(19) United States
(12) Patent Application Publication
(10) Pub. No.: US 2026/0036855 A1
(43) Pub. Date: Feb. 5, 2026

(54) DISPLAY

(71) Applicant: Sharp Display Technology Corporation, Kameyama City (JP)

(72) Inventors: Takehiro KITAURA, Kameyama City (JP); Masatomo HONJO, Kameyama City (JP)

(21) Appl. No.: 19/213,011

(22) Filed: May 20, 2025

(30) Foreign Application Priority Data
Jul. 30, 2024 (JP) 2024-123416

(51) Int. Cl. G02F 1/1368; G02F 1/1362

(52) U.S. Cl. CPC G02F 1/1368; G02F 1/136286

(57) ABSTRACT

A TFT for each of sub-pixels constituting a display region includes: a semiconductor layer that is composed of an oxide semiconductor and in which a channel region, a source region, and a drain region are defined; a first gate electrode disposed on the side of the semiconductor layer facing the base substrate, the first gate electrode overlapping the channel region with a first gate insulating film therebetween; and a second gate electrode disposed on the side of the semiconductor layer facing away from the base substrate, the second gate electrode overlapping the channel region with a second gate insulating film therebetween. The semiconductor layer has a planar shape due to an organic insulating film that is disposed on the side of the semiconductor layer facing the base substrate and that overlaps at least the source region and the drain region.

### BACKGROUND

### 1. Field

The present disclosure relates to a display.

### 2. Description of the Related Art

In recent years, displays such as liquid crystal displays have employed a thin film transistor (hereinafter also referred to as TFT) as a switching element in each sub-pixel, which is the smallest unit of an image. For example, semiconductor layers composed of polysilicon with high mobility and semiconductor layers composed of oxide semiconductors, such as In-Ga-Zn-O semiconductors with low leakage current, are well known as semiconductor layers used in TFTs.

For example, Japanese Unexamined Patent Application Publication No. 2023-16840 discloses a semiconductor device structure in which an oxide semiconductor film is formed on an oxide insulating film having the surface planarized by chemical mechanical polishing to prevent or reduce step disconnection in the oxide semiconductor film.

A semiconductor layer (hereinafter also referred to as “oxide semiconductor layer”) composed of an oxide semiconductor includes a channel region overlapping gate electrodes, and a conductive source region and a conductive drain region that are separated from each other by the channel region. In a TFT having a double gate structure in which gate electrodes are disposed above and below the oxide semiconductor layer with a respective one of inorganic insulating films therebetween, not only does the oxide semiconductor layer easily undergo step disconnection due to the cross-sectional shape of the lower gate electrode and the inorganic insulating film, but also the source region and drain region of the oxide semiconductor layer exhibit increased electrical resistance, making it difficult to achieve a high on-current. Therefore, there is room for improvement.

It is desirable to prevent or reduce occurrence of step disconnection in the oxide semiconductor layer and lower the resistance of a source region and a drain region of an oxide semiconductor layer in a TFT having a double gate structure.

### SUMMARY

According to an aspect of the disclosure, there is provided a display including: a base substrate; and a thin film transistor layer disposed on the base substrate and including a thin film transistor for each of sub-pixels constituting a display region, wherein the thin film transistor includes: a semiconductor layer composed of an oxide semiconductor and including a source region and a drain region defined to be separate from each other and a channel region defined between the source region and the drain region; a first gate electrode disposed on a side of the semiconductor layer facing the base substrate, the first gate electrode overlapping the channel region with a first gate insulating film therebetween; and a second gate electrode disposed on a side of the semiconductor layer facing away from the base substrate, the second gate electrode overlapping the channel region with a second gate insulating film therebetween, and wherein the semiconductor layer has a planar shape due to an organic insulating film disposed on the side of the semiconductor layer facing the base substrate, the organic insulating film overlapping at least the source region and the drain region.

### BRIEF DESCRIPTION OF THE DRAWINGS

FIG. 1 is a schematic plan view of a liquid crystal display according to a first embodiment of the present disclosure;

FIG. 2 is a plan view of an active matrix substrate in the liquid crystal display according to the first embodiment of the present disclosure;

FIG. 3 is a cross-sectional view of the active matrix substrate and the liquid crystal display including the active matrix substrate taken along line III-III in FIG. 2;

FIG. 4 is a cross-sectional view illustrating a part of the TFT formation step in a process for manufacturing the active matrix substrate in the liquid crystal display according to the first embodiment of the present disclosure;

FIG. 5 is a cross-sectional view illustrating a part of the TFT formation step, following FIG. 4;

FIG. 6 is a cross-sectional view illustrating a part of the TFT formation step, following FIG. 5;

FIG. 7 is a cross-sectional view illustrating a part of the TFT formation step, following FIG. 6;

FIG. 8 is a cross-sectional view of an active matrix substrate in a liquid crystal display according to a second embodiment of the present disclosure; and

FIG. 9 is a different cross-sectional view of the active matrix substrate in the liquid crystal display according to the second embodiment of the present disclosure.

### DESCRIPTION OF THE EMBODIMENTS

A detailed description of embodiments of the present disclosure is provided below with reference to the drawings. The present disclosure is not limited to the following embodiments.

### First Embodiment

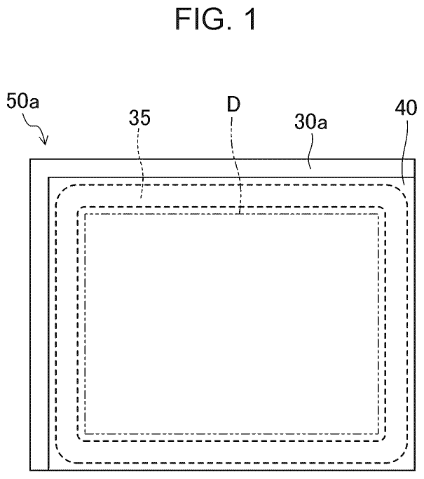

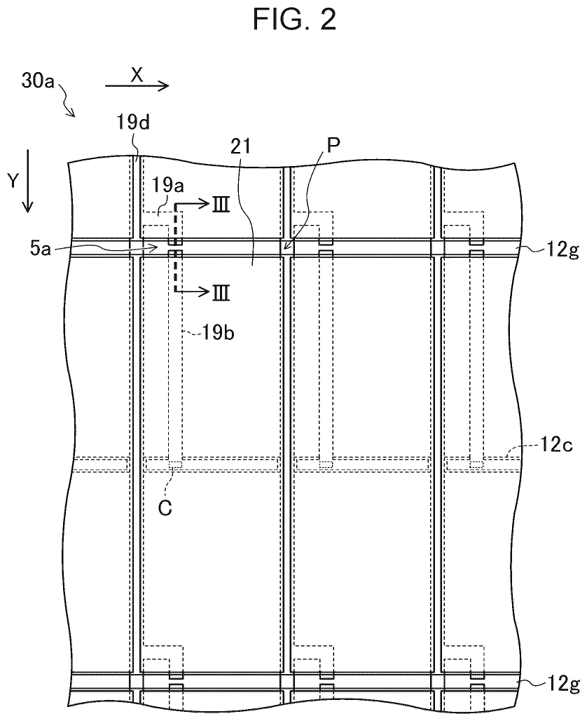

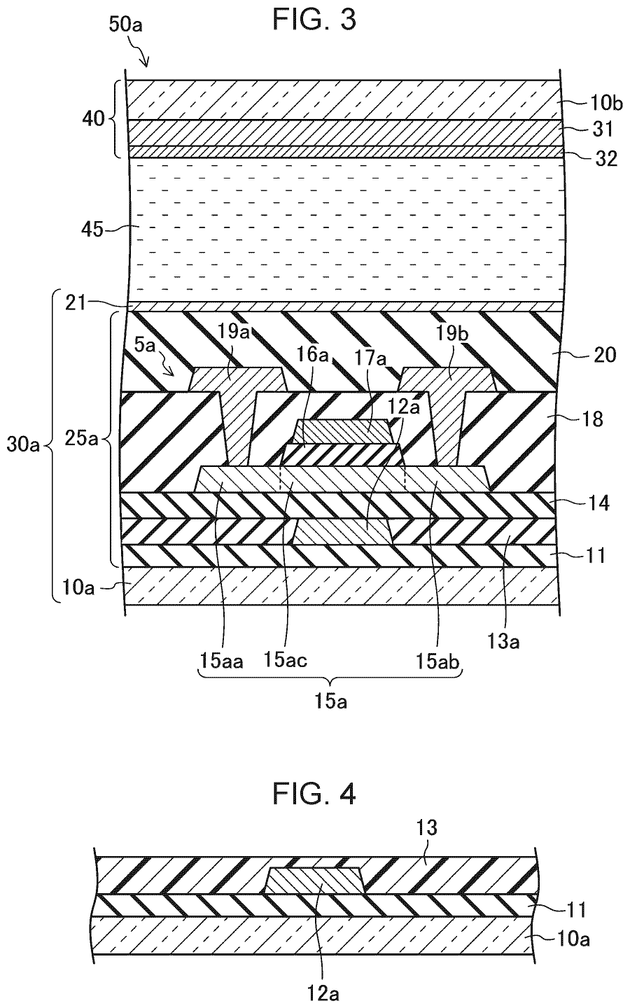

FIGS. 1 to 7 illustrate a first embodiment of a display according to the present disclosure. In each of the following embodiments, a liquid crystal display is illustrated as an example of a display. FIG. 1 is a schematic plan view of a liquid crystal display 50a according to this embodiment. FIG. 2 is a plan view of an active matrix substrate 30a in the liquid crystal display 50a. FIG. 3 is a cross-sectional view of the active matrix substrate 30a and the liquid crystal display 50a including the active matrix substrate 30a taken along line III-III in FIG. 2.

Referring to FIGS. 1 and 3, the liquid crystal display 50a includes the active matrix substrate 30a and an opposing substrate 40 disposed opposite each other, and a liquid crystal layer 45 disposed between the active matrix substrate 30a and the opposing substrate 40. Referring to FIG. 1, in the liquid crystal display 50a, a plurality of sub-pixels P (see FIG. 2) are arranged in a matrix in a display region D for displaying images inside a sealant 35 described below. In the display region D, for example, sub-pixels P for displaying red gradations, sub-pixels P for displaying green gradations, and sub-pixels P for displaying blue gradations are arranged adjacent to each other. In the display region D, three adjacent sub-pixels P for displaying red, green, and blue gradations constitute one pixel.

Referring to FIG. 3, the active matrix substrate 30a has a base substrate 10a, such as a glass substrate, a TFT layer 25a disposed on the base substrate 10a, a plurality of pixel electrodes 21 arranged in a matrix on the TFT layer 25a, and an alignment film (not shown) covering each of the pixel electrodes 21.

Referring to FIG. 3, the TFT layer 25a includes a base coat film 11 disposed on the base substrate 10a, a plurality of TFTs 5a arranged on the base coat film 11 to correspond to a plurality of sub-pixels P, and a second interlayer insulating film 20 disposed on each of the TFTs 5a. Referring to FIG. 2, in the TFT layer 25a, a plurality of gate lines 12g extend in parallel with each other in the X direction in the figure. Referring to FIG. 2, in the TFT layer 25a, a plurality of capacitor lines 12c extend in parallel with each other in the X direction in the figure. Referring to FIG. 2, each capacitor line 12c is adjacent to a respective gate line 12g. Referring to FIG. 2, in the TFT layer 25a, a plurality of source lines 19d extend in parallel with each other in a direction that intersects (perpendicularly) the plurality of gate lines 12g, that is, in the Y direction in the figure. Referring to FIG. 2, in the TFT layer 25a, one TFT 5a is provided per sub-pixel P, that is, in each of the sub-pixels P at the intersections of the gate lines 12g and the source lines 19d.

The base coat film 11 and the second interlayer insulating film 20 as well as a second gate insulating film 16a and a first interlayer insulating film 18 described below are composed of, for example, single-layer or multilayer inorganic insulating films made of silicon nitride, silicon oxide, silicon oxynitride, or aluminum oxide.

Referring to FIG. 3, the TFT 5a includes: a semiconductor layer 15a composed of an oxide semiconductor, such as an In-Ga-Zn-O semiconductor; a first gate electrode 12a disposed on the side of the semiconductor layer 15a facing the base substrate 10a with a first gate insulating film 14 therebetween; a second gate electrode 17a disposed on the side of the semiconductor layer 15a facing away from the base substrate 10a with the second gate insulating film 16a therebetween; and a source electrode 19a and a drain electrode 19b separate from each other and disposed on the first interlayer insulating film 18 covering the second gate electrode 17a.

Referring to FIG. 3, the semiconductor layer 15a includes a source region 15aa and a drain region 15ab defined to be separate from each other and a channel region 15ac defined between the source region 15aa and the drain region 15ab. Referring to FIG. 3, the semiconductor layer 15a has a planar shape due to an organic insulating film 13a that is disposed on the side of the semiconductor layer 15a facing the base substrate 10a and that overlaps at least the source region 15aa and the drain region 15ab. Referring to FIG. 3, the organic insulating film 13a is adjacent to the first gate electrode 12a, and the surface (top surface in the figure) of the organic insulating film 13a facing away from the base substrate 10a is flush with the surface (top surface in the figure) of the first gate electrode 12a facing away from the base substrate 10a. The flush surface alignment does not necessitate that the surfaces be perfectly flush with each other, but small step height variations are acceptable as long as step disconnection is unlikely to occur.

The first gate insulating film 14 is gas permeable and is composed of, for example, a single-layer inorganic insulating film made of silicon oxide or other materials. Referring to FIG. 3, the first gate insulating film 14 has a planar shape on the surface (top surface in the figure) of the organic insulating film 13a facing away from the base substrate 10a and the surface (top surface in the figure) of the first gate electrode 12a facing away from the base substrate 10a.

Referring to FIG. 3, the first gate electrode 12a overlaps the channel region 15ac of the semiconductor layer 15a and is configured to control conduction between the source region 15aa and the drain region 15ab of the semiconductor layer 15a. Referring to FIG. 2, the first gate electrode 12a is formed by a portion of the gate line 12g.

Referring to FIG. 3, the second gate electrode 17a overlaps the channel region 15ac of the semiconductor layer 15a and is configured to control conduction between the source region 15aa and the drain region 15ab of the semiconductor layer 15a. The second gate electrode 17a is electrically connected to the first gate electrode 12a.

Referring to FIG. 3, the source electrode 19a and the drain electrode 19b are respectively electrically connected to the source region 15aa and the drain region 15ab of the semiconductor layer 15a through respective contact holes formed in the first interlayer insulating film 18.

Referring to FIG. 2, the source electrode 19a is an L-shaped portion protruding sideways from the source line 19d in each sub-pixel P. Referring to FIG. 2, the drain electrode 19b extends to a region overlapping the capacitor line 12c in each sub-pixel P, and the drain electrode 19b together with the first gate insulating film 14 between the drain electrode 19b and the capacitor line 12c forms an auxiliary capacitance. In each sub-pixel P, the drain electrode 19b is electrically connected to the pixel electrode 21 through a contact hole C formed in the second interlayer insulating film 20 above the capacitor line 12c, as illustrated in FIG. 2. In this embodiment, an auxiliary capacitance is formed by the extension of the drain electrode 19b to a region overlapping the capacitor line 12c. For example, an auxiliary capacitance may be formed by the extension of the drain region 15ab to a region overlapping the capacitor line 12c.

Referring to FIGS. 2 and 3, the pixel electrode 21 is formed in a rectangular shape on the second interlayer insulating film 20 in each sub-pixel P.

Referring to FIG. 3, the opposing substrate 40 has, for example, a base substrate 10b, such as a glass substrate, a color filter layer 31 disposed on the base substrate 10b, a common electrode 32 disposed on the color filter layer 31, and an alignment film (not shown) disposed on the common electrode 32.

The color filter layer 31 has, for example, a plurality of color layers (e.g., a red layer, a green layer, a blue layer) arranged in a matrix to correspond to a plurality of sub-pixels P, and a black matrix disposed between the plurality of color layers.

The common electrode 32 is common to the plurality of sub-pixels P.

The alignment films in the active matrix substrate 30a and the opposing substrate 40 are composed of, for example, a polyimide resin with a rubbed surface.

The liquid crystal layer 45 is composed of, for example, a nematic liquid crystal material having electro-optical properties. The liquid crystal layer 45 is sealed between the active matrix substrate 30a and the opposing substrate 40 by using a frame-shaped sealant 35 that bonds the active matrix substrate 30a and the opposing substrate 40 to each other around the display region D.

When the TFT 5a is turned on in each pixel P in the liquid crystal display 50a, a potential difference is generated between the pixel electrode 21 and the common electrode 32 to apply a predetermined voltage across the liquid crystal capacitance formed by the liquid crystal layer 45 and the auxiliary capacitance electrically connected in parallel to the liquid crystal capacitance. The liquid crystal display 50a displays images by adjusting the transmittance of the liquid crystal layer 45 for light incident from the outside through changes in the alignment state of the liquid crystal molecules according to the magnitude of the voltage applied across the liquid crystal layer 45 in each pixel P.

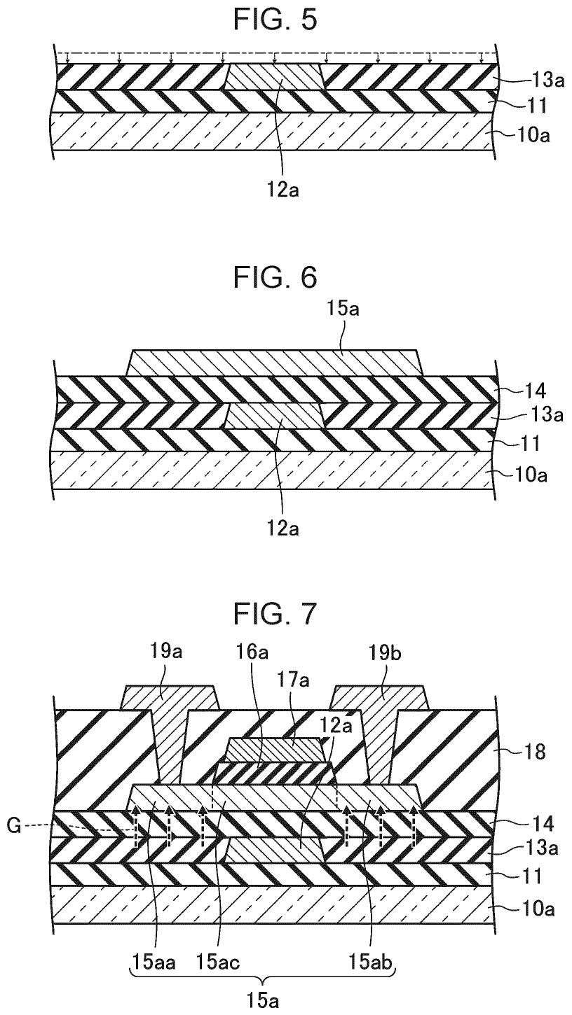

Next, the method for manufacturing the liquid crystal display 50a in this embodiment will be described, focusing on the method for manufacturing the active matrix substrate 30a. FIG. 4, FIG. 5, FIG. 6, and FIG. 7 are cross-sectional views sequentially illustrating parts of the step of forming the TFT 5a in the process for manufacturing the active matrix substrate 30a.

### Active Matrix Substrate

First, the base coat film 11 is formed by depositing an inorganic insulating film (about 300 nm thick), such as a silicon oxide film, on the base substrate 10a, such as a glass substrate, by, for example, plasma chemical vapor deposition (CVD).

Subsequently, a metal film (about 300 nm thick), such as a titanium film, is deposited on the substrate surface having the base coat film 11 thereon by sputtering, and the metal film is then subjected to photolithography, etching, and resist stripping and cleaning to form the gate lines 12g including the first gate electrode 12a, the capacitor lines 12c, and the like.

Then, an acrylic organic resin material (about 2.0 μm thick) is applied to the substrate surface having the gate lines 12g and the like thereon by, for example, spin coating or slit coating, and the applied organic resin material is fired to form an organic resin film 13, as illustrated in FIG. 4. The organic resin film 13 may be patterned by exposure, development, and firing using a photosensitive organic resin material.

Furthermore, the substrate surface having the organic resin film 13 thereon is subjected to dry etching, physical polishing, or other processing so that no organic resin film 13 remains on the first gate electrode 12a to form the organic insulating film 13a as illustrated in FIG. 5.

Subsequently, an inorganic insulating film (about 300 nm thick), such as a silicon oxide film, is deposited on the substrate surface having the organic insulating film 13a thereon by, for example, plasma CVD to form the first gate insulating film 14.

Subsequently, an oxide semiconductor film (about 30 nm thick), such as an InGaZnO₄ film, is deposited on the substrate surface having the first gate insulating film 14 thereon by sputtering, and the oxide semiconductor film is then subjected to photolithography, etching, and resist stripping and cleaning to form the semiconductor layer 15a and the like, as illustrated in FIG. 6.

Furthermore, an inorganic insulating film (about 300 nm thick), such as a silicon nitride film, is deposited on the substrate surface having the semiconductor layer 15a and the like thereon by, for example, plasma CVD, and a metal film, such as a titanium film (about 300 nm thick), is deposited by sputtering. A multilayer film including the inorganic insulating film and the metal film is then subjected to photolithography, etching, and resist stripping and cleaning to form the second gate insulating film 16a and the second gate electrode 17a and the like.

Subsequently, an inorganic insulating film (about 300 nm thick), such as a silicon nitride film, is deposited on the substrate surface having the second gate electrode 17a and the like thereon by, for example, plasma CVD, and the inorganic insulating film is then subjected to photolithography, etching, and resist stripping and cleaning to form the first interlayer insulating film 18.

Furthermore, a titanium film (about 50 nm thick), an aluminum film (about 300 nm thick), a titanium film (about 50 nm thick), and the like are sequentially deposited on the substrate surface having the first interlayer insulating film 18 thereon by, for example, sputtering to form a metal film, and the metal film is then subjected to photolithography, etching, and resist stripping and cleaning to form the source lines 19d including the source electrode 19a, and the drain electrode 19b and the like, as illustrated in FIG. 7. With regard to the semiconductor layer 15a, for example, part of the semiconductor layer 15a becomes conductive to form the source region 15aa, the drain region 15ab, and the channel region 15ac due to the supply of desorbed gas G from the organic insulating film 13a to the semiconductor layer 15a through the first gate insulating film 14, as illustrated in FIG. 7, in the heat treatment after forming the first interlayer insulating film 18.

Furthermore, an inorganic insulating film (about 300 nm thick), such as a silicon nitride film, is deposited on the substrate surface having the drain electrode 19b and the like thereon by, for example, plasma CVD, and the inorganic insulating film is then subjected to photolithography, etching, and resist stripping and cleaning to form the second interlayer insulating film 20.

Subsequently, a transparent conducting film (about 100 nm thick), such as an indium tin oxide (ITO) film, is deposited on the substrate surface having the second interlayer insulating film 20 thereon by, for example, sputtering, and the transparent conducting film is then subjected to photolithography, etching, and resist stripping and cleaning to form the pixel electrode 21.

Finally, a polyimide resin film is applied to the entire substrate having the pixel electrode 21 thereon by, for example, printing, and the resin film is then subjected to baking and rubbing to form an alignment film.

The active matrix substrate 30a can be manufactured as described above.

Furthermore, the active matrix substrate 30a manufactured as described above is bonded to the opposing substrate 40 using the frame-shaped sealant 35, and a liquid crystal material is sealed between the active matrix substrate 30a and the opposing substrate 40 to form the liquid crystal layer 45, whereby the liquid crystal display 50a can be manufactured.

According to the liquid crystal display 50a of this embodiment, as described above, the organic insulating film 13a disposed on the side of the semiconductor layer 15a facing the base substrate 10a and overlapping the source region 15aa and the drain region 15ab is adjacent to the first gate electrode 12a, and the surface of the organic insulating film 13a facing away from the base substrate 10a is flush with the surface of the first gate electrode 12a facing away from the base substrate 10a. The first gate insulating film 14 on the surface of the organic insulating film 13a facing away from the base substrate 10a and the surface of the first gate electrode 12a facing away from the base substrate 10a is thus formed in a planar shape, and the semiconductor layer 15a on the first gate insulating film 14 is also formed in a planar shape. This configuration can prevent or reduce occurrence of step disconnection in the semiconductor layer 15a in the TFT 5a having the first gate electrode 12a and the second gate electrode 17a. Since the organic insulating film 13a overlaps the source region 15aa and the drain region 15ab of the semiconductor layer 15a composed of an oxide semiconductor, the desorbed gas G from the organic insulating film 13a can lower the resistance of the drain region 15ab and the channel region 15ac, which results in a high on-current. It is thus possible to prevent or reduce occurrence of step disconnection in the semiconductor layer 15a and lower the resistance of the source region 15aa and the drain region 15ab of the semiconductor layer 15a in the TFT 5a having a double gate structure.

### Second Embodiment

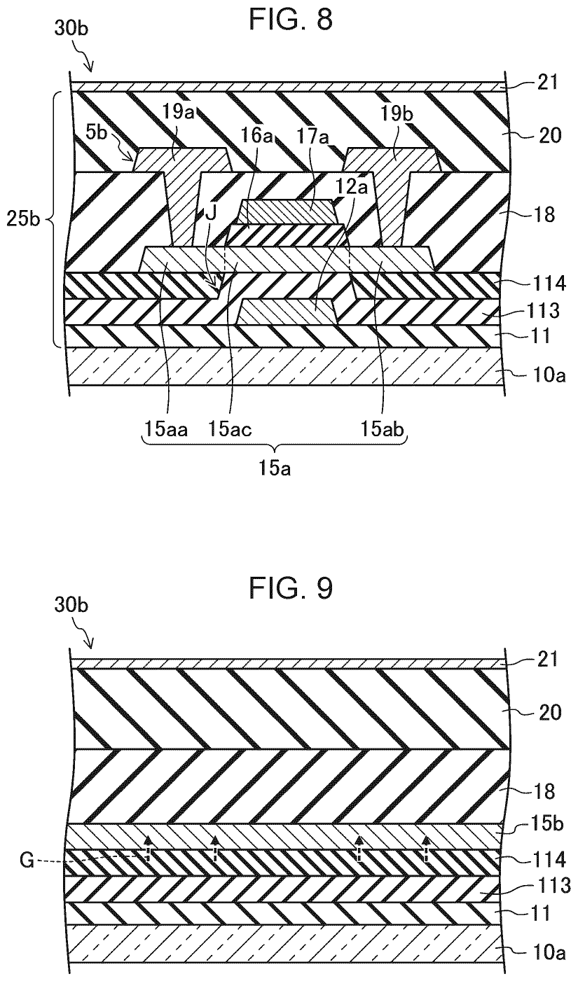

FIGS. 8 and 9 illustrate a second embodiment of a display according to the present disclosure. FIG. 8 is a cross-sectional view of an active matrix substrate 30b in a liquid crystal display according to this embodiment and corresponds to the view of the active matrix substrate 30a in FIG. 3. FIG. 9 is a different cross-sectional view of the active matrix substrate 30b. In each of the following embodiments, the same components as those in FIGS. 1 to 7 are denoted by the same reference signs, and detailed descriptions thereof are omitted.

The first embodiment illustrates the active matrix substrate 30a in which the source region 15aa and the drain region 15ab of the semiconductor layer 15a are separate from the organic insulating film 13a in the thickness direction. This embodiment illustrates the active matrix substrate 30b in which the source region 15aa and the drain region 15ab of the semiconductor layer 15a are in contact with an organic insulating film 114 in the thickness direction.

The liquid crystal display of this embodiment includes the active matrix substrate 30b (see FIG. 8) and an opposing substrate 40 (see FIG. 3) disposed opposite each other, and a liquid crystal layer 45 (see FIG. 3) disposed between the active matrix substrate 30b and the opposing substrate 40. In the liquid crystal display of this embodiment, a plurality of sub-pixels P are arranged in a matrix in a display region D for displaying images inside a sealant 35, as in the liquid crystal display 50a of the first embodiment.

Referring to FIG. 8, the active matrix substrate 30b includes: a base substrate 10a; a TFT layer 25b disposed on the base substrate 10a; a plurality of pixel electrodes 21 arranged in a matrix on the TFT layer 25b; and an alignment film (not shown) covering each of the pixel electrodes 21.

Referring to FIG. 8, the TFT layer 25b includes a base coat film 11 disposed on the base substrate 10a, a plurality of TFTs 5b arranged on the base coat film 11 to correspond to a plurality of sub-pixels P, and a second interlayer insulating film 20 disposed on each of the TFTs 5b. The TFT layer 25b includes a plurality of gate lines 12g, a plurality of capacitor lines 12c, and a plurality of source lines 19d, like the TFT layer 25a in the first embodiment. The TFT layer 25b includes a TFT 5b per sub-pixel P, that is, in each of the sub-pixels P at the intersections of the gate lines 12g and the source lines 19d, like the TFT layer 25a in the first embodiment. Referring to FIG. 9, the TFT layer 25b includes a wiring layer 15b composed of an oxide semiconductor, such as an In-Ga-Zn-O semiconductor, and includes the organic insulating film 114 on the side of the wiring layer 15b facing the base substrate 10a.

Referring to FIG. 8, the TFT 5b includes: a semiconductor layer 15a composed of an oxide semiconductor, such as an In-Ga-Zn-O semiconductor; a first gate electrode 12a disposed on the side of the semiconductor layer 15a facing the base substrate 10a with a first gate insulating film 113 therebetween; a second gate electrode 17a disposed on the side of the semiconductor layer 15a facing away from the base substrate 10a with a second gate insulating film 16a therebetween; and a source electrode 19a and a drain electrode 19b separate from each other and disposed on the first interlayer insulating film 18 covering the second gate electrode 17a.

Referring to FIG. 8, the semiconductor layer 15a has a planar shape due to the organic insulating film 114 that is disposed on the side of the semiconductor layer 15a facing the base substrate 10a and that overlaps at least the source region 15aa and the drain region 15ab. Referring to FIG. 8, the organic insulating film 114 is adjacent to a protrusion J of the first gate insulating film 113 described below, and the surface (top surface in the figure) of the organic insulating film 114 facing away from the base substrate 10a is flush with the surface (top surface in the figure) of the protrusion J facing away from the base substrate 10a. Referring to FIG. 8, the semiconductor layer 15a thus has a planar shape on the surface (top surface in the figure) of the organic insulating film 114 facing away from the base substrate 10a and the surface (top surface in the figure) of the protrusion J facing away from the base substrate 10a.

The first gate insulating film 113 is composed of, for example, a single-layer or multilayer inorganic insulating film made of silicon nitride, silicon oxide, silicon oxynitride, or aluminum oxide, like the base coat film 11, the second gate insulating film 16a, the first interlayer insulating film 18, and the second interlayer insulating film 20. Referring to FIG. 8, the first gate insulating film 113 covers the first gate electrode 12a and has the protrusion J in a portion overlapping the first gate electrode 12a.

Like the liquid crystal display 50a of the first embodiment, the liquid crystal display including the active matrix substrate 30b described above displays images by applying a predetermined voltage across the liquid crystal capacitance and the liquid crystal layer 45 between each pixel electrode 21 and the common electrode 32 to change the alignment state of the liquid crystal layer 45 and thereby adjusting the transmittance of the liquid crystal layer 45 for light incident from the outside.

The active matrix substrate 30b of this embodiment can be manufactured as follows: in the method for manufacturing the active matrix substrate 30a of the first embodiment, first, an inorganic insulating film (about 300 nm thick), such as a silicon oxide film, is deposited on the substrate surface having gate lines 12g (including the first gate electrode 12a) and the like thereon by, for example, plasma CVD to form the first gate insulating film 113 having the protrusion J; subsequently, an acrylic organic resin material (about 2.0 μm thick) is applied by, for example, spin coating or slit coating, and the applied organic resin material is fired to form an organic resin film; the substrate surface having the organic resin film thereon is then subjected to dry etching, physical polishing, or other processing so that no organic resin film remains on the protrusion J to form the organic insulating film 114; and the semiconductor layer 15a and other layers are then formed sequentially as in the method for manufacturing the active matrix substrate 30a of the first embodiment. The wiring layer 15b is patterned when forming the semiconductor layer 15a and becomes conductive when forming the source region 15aa and the drain region 15ab by subsequent heat treatment.

According to the liquid crystal display including the active matrix substrate 30b in this embodiment, as described above, the organic insulating film 114 disposed on the side of the semiconductor layer 15a facing the base substrate 10a and overlapping the source region 15aa and the drain region 15ab is adjacent to the protrusion J of the first gate insulating film 113, and the surface of the organic insulating film 114 facing away from the base substrate 10a is flush with the surface of the protrusion J facing away from the base substrate 10a. The semiconductor layer 15a on the surface of the organic insulating film 114 facing away from the base substrate 10a and the surface of the protrusion J facing away from the base substrate 10a is thus formed in a planar shape, and it is possible to prevent or reduce occurrence of step disconnection in the semiconductor layer 15a in the TFT 5b having the first gate electrode 12a and the second gate electrode 17a. Since the organic insulating film 114 is disposed in contact with and overlaps the source region 15aa and the drain region 15ab of the semiconductor layer 15a composed of an oxide semiconductor, the desorbed gas G from the organic insulating film 114 can further lower the resistance of the drain region 15ab and the channel region 15ac, which results in a higher on-current. It is thus possible to prevent or reduce occurrence of step disconnection in the semiconductor layer 15a and lower the resistance of the source region 15aa and the drain region 15ab of the semiconductor layer 15a in the TFT 5b having a double gate structure.

Since the TFT layer 25b includes the wiring layer 15b composed of an oxide semiconductor and includes the organic insulating film 114 on the side of the wiring layer 15b facing the base substrate 10a according to the liquid crystal display including the active matrix substrate 30b in this embodiment, the desorbed gas G from the organic insulating film 114 can further lower the resistance of the wiring layer 15b.

### Other Embodiments

In the above embodiments, the liquid crystal displays are illustrated as examples of displays. The present disclosure can also be applied to organic electroluminescent displays and other devices.

In the above embodiments, the liquid crystal display devices including a TFT substrate having a TFT whose electrode connected to a pixel electrode functions as a drain electrode are illustrated as examples. The present disclosure can also be applied to, for example, liquid crystal displays having a TFT whose electrode connected to a pixel electrode is referred to as a source electrode.

As described above, the present disclosure is useful for an active matrix substrate including TFTs each having a double gate structure and a display including the active matrix substrate.

The present disclosure contains subject matter related to that disclosed in Japanese Priority Patent Application JP 2024-123416 filed in the Japan Patent Office on Jul. 30, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display comprising:
a substrate; and
a thin film transistor layer disposed on the substrate and including a thin film transistor for each of sub-pixels constituting a display region,
wherein the thin film transistor includes:
a semiconductor layer composed of an oxide semiconductor and including a source region and a drain region defined to be separate from each other and a channel region defined between the source region and the drain region;
a first gate electrode disposed on a side of the semiconductor layer facing the substrate, the first gate electrode overlapping the channel region with a first gate insulating film therebetween; and
a second gate electrode disposed on a side of the semiconductor layer facing away from the substrate, the second gate electrode overlapping the channel region with a second gate insulating film therebetween, and
the semiconductor layer has a planar shape due to an organic insulating film disposed on the side of the semiconductor layer facing the substrate, the organic insulating film overlapping at least the source region and the drain region.

2. The display according to claim 1,
wherein the organic insulating film is adjacent to the first gate electrode,
a surface of the organic insulating film facing away from the substrate is flush with a surface of the first gate electrode facing away from the substrate, and
the first gate insulating film is disposed on the surface of the organic insulating film facing away from the substrate and the surface of the first gate electrode facing away from the substrate.

3. The display according to claim 2, wherein the first gate insulating film is composed of a silicon oxide film.

4. The display according to claim 1,
wherein the first gate insulating film covers the first gate electrode and has a protrusion in a portion overlapping the first gate electrode,
the organic insulating film is adjacent to the protrusion,
a surface of the organic insulating film facing away from the substrate is flush with a surface of the protrusion facing away from the substrate, and
the semiconductor layer is disposed on the surface of the organic insulating film facing away from the substrate and the surface of the protrusion facing away from the substrate.

5. The display according to claim 4, wherein the thin film transistor layer includes a wiring layer composed of an oxide semiconductor and includes the organic insulating film on a side of the wiring layer facing the substrate.

6. The display according to claim 1, wherein the thin film transistor includes a source electrode and a drain electrode that are separated from each other by an interlayer insulating film covering the second gate electrode, the source electrode and the drain electrode being electrically connected to the source region and the drain region, respectively.

7. The display according to claim 6,
wherein the substrate, the thin film transistor layer, and a plurality of pixel electrodes arranged in a matrix on the thin film transistor layer and electrically connected to the drain electrode of the corresponding thin film transistor constitute an active matrix substrate, and
the display further comprises:
an opposing substrate disposed opposite the active matrix substrate; and
a liquid crystal layer disposed between the active matrix substrate and the opposing substrate.
